(19) United States
(12) Patent Application Publication
(10) Pub. No.: US 2012/0124989 A1
(43) Pub. Date: May 24, 2012

(54) Hydraulic Power Unit With Auto-Load Sensing

(76) Inventors: Robert A. Doll, Nashotah, WI (US); John G. Steidtman, Waterford, WI (US); William R. Reuter, III, Oconomowoc, WI (US)

(21) Appl. No.: 12/953,694

(22) Filed: Nov. 24, 2010

(51) Int. Cl. F15B 13/02; F15B 11/05; F15B 13/00

(52) U.S. Cl. 60/468; 60/494; 60/721

(57) ABSTRACT

A hydraulic power unit is disclosed that is selectively connectable to a hydraulic tool. The hydraulic power unit automatically detects the attached or detached state of the tool and/or operates an unloading valve during activation of the tool.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

This invention relates to hydraulic systems. In particular, this invention relates to hydraulic systems in which a hydraulic power unit drives a selectively connectable rescue tool.

During car accidents or the like, injured individuals may be trapped in difficult to access locations. For example, a car that rolls off the road may incur body damage which prevents rescue crews from easily accessing the inside of the car. In these types of situations, emergency workers must move quickly to extract the injured individuals from the vehicle.

In many rescue operations, hydraulic tools are used to cut, spread, or ram portions of the vehicle to provide access to the injured individuals inside the car. Typically, the hydraulic tools are connected to a hydraulic pump which pumps a hydraulic fluid through hydraulic lines to power the connected tool at a remote location.

However, it is often the case that more than one type of tool will be needed during a rescue operation. Depending on the particular hydraulic pump and tools being used, this means that the original tool must be disconnected from the pump and that the new tool must be connected. Changing the tool wastes valuable minutes as the hydraulic pressure in the system must be reduced, the original, tool disconnected, the new tool connected, and the system brought back up to an operating pressure. Further complicating matters is the fact that the location of the hydraulic pump may remain at a higher elevation than or at some distance from the tool being used. When only a few rescue workers are available, this may mean that a rescue worker will need to travel from the location of the accident back to the vehicle on which the pump is carried to initiate the sequence of events necessary to change tools.

Hence, a need exists for an improved hydraulic system for rescue equipment and other hydraulic tools. In particular, a need exists for a faster way to change tools on a hydraulic power unit.

### SUMMARY OF THE INVENTION

A significant problem with prior hydraulic systems having connectable tools is that the hydraulic power units were not smart. That is, the hydraulic power units did not sense whether a tool was connected and, if a tool was connected, whether the tool was in operation. Ultimately, this made those systems less efficient in that the system would rise to significant pressure after the connection of the tool, whether the tool was active or not.

A hydraulic power unit is disclosed that is selectively connectable to a hydraulic tool. The hydraulic power unit detects the attached or detached state of the tool and/or operates an unloading valve during activation of the tool to provide the tool with power when the tool is active.

These and still other advantages of the invention will be apparent from the detailed description and drawings. What follows is merely a description of a preferred embodiment of the present invention. To assess the full scope of the invention the claims should be looked to as this preferred embodiment is not intended to be the only embodiment within the scope of the claims.

### BRIEF DESCRIPTION OF THE DRAWINGS

FIG. 1 is a schematic of a hydraulic power unit with a hydraulic tool attached;

FIG. 2 is a control state diagram for the hydraulic power unit;

FIG. 3 is a perspective view of the hydraulic power unit to which a sensor and control manifold is coupled; and

FIG. 4 is a perspective view of the sensor and control manifold.

### DETAILED DESCRIPTION OF THE PREFERRED EMBODIMENT

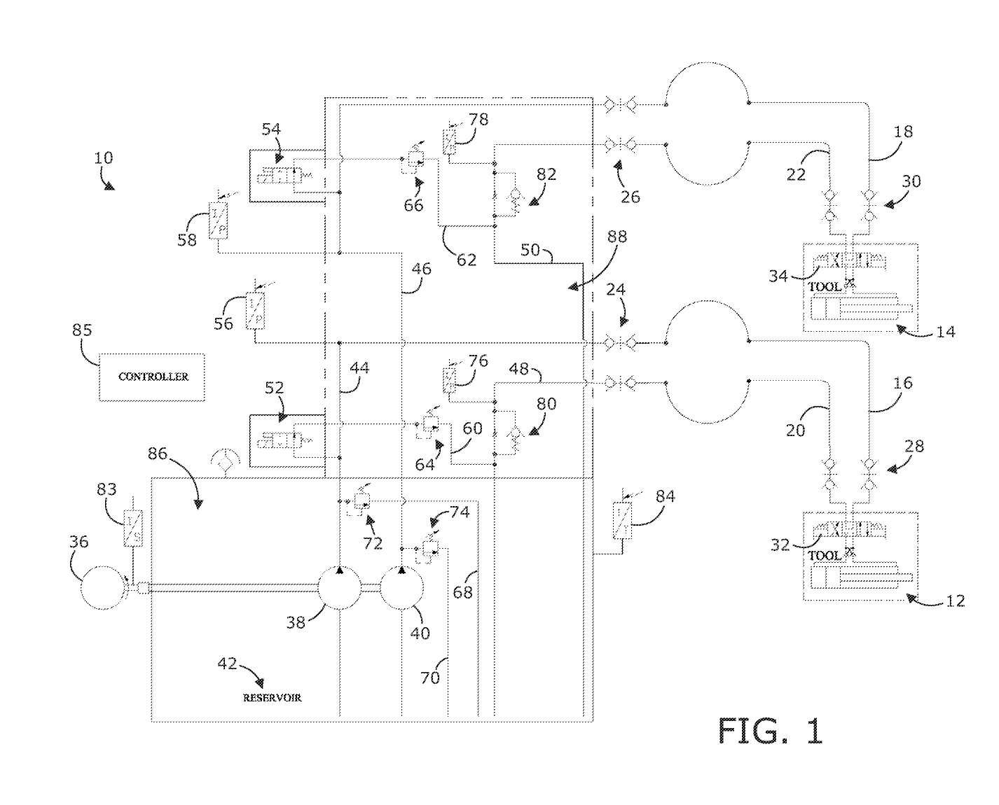

Referring first to FIG. 1, a hydraulic schematic illustrates a hydraulic system including a hydraulic power unit 10 to which two hydraulic tools 12, 14 are coupled via hydraulic pressure hoses 16, 18 and return hoses 20, 22. In the form shown, the pressure hoses 16, 18 and the return hoses 20, 22 are separately connectable, on one end, to one of the sets of quick release couplings 24, 26 on the hydraulic power unit 10 and, on the other end, to a set of quick release couplings 28, 30 on the hydraulic tools 12, 14. These hoses are typically 30 to 150 feet in length such that the tools 12, 14 may be operated at a distance from the hydraulic power unit 10.

The hydraulic tools 12, 14 may be hydraulic hand tools powered by pressurized hydraulic fluid. These tools 12, 14 may any of a number of type of tools including for example, hydraulic rescue tools used in road-side rescue operations. In the form shown in FIG. 1, each of the hydraulic tools 12, 14 include a forward-inactive-reverse control valve 32, 34. These valves 32, 34 are operable by a user to control the tools 12, 14 when the tools 12, 14 are connected to the hydraulic power unit 10. Depending on the state of the control valve 32, 34, the flow of hydraulic fluid is directed through each of the tools 12, 14 to operate the tool in the particular manner desired or to maintain the tool an inactive state. Even in the inactive state however, some amount of hydraulic fluid will circulate through the tool 12, 14.

In the form shown in FIG. 1, the hydraulic power unit 10 includes two sets of couplings 24, 26 for the attachment of two hydraulic tools 12, 14. However, the hydraulic power unit 10 may be configured to receive one or more than two hydraulic tools. Those of skill in the art will appreciate that a hydraulic power unit may be readily adapted to connect and operate more than two tools, given sufficient power, by duplicating one of the two hydraulic circuit portions described below.

Turning now to the hydraulic power unit 10, a motor 36 energizes two hydraulic pumps 38, 40 via rotary motion of a shaft connected to the motor 36 and the hydraulic pumps 38, 40. The motor 36 may be a gas, diesel, or electric motor. When the hydraulic pumps 38, 40 are energized, they pump a hydraulic fluid from a reservoir 42 through the hydraulic circuit attached to the pumps 38, 40. The pumps 38, 40 for this hydraulic power unit 10 are each two stage pumps having a first, low pressure, stage which transports hydraulic fluid at, for example, 245 cubic inches per minute at 3,200 psi and second, high pressure, stage which pumps hydraulic fluid at, for example, 85 cubic inches per minute at 10,500 psi.

For each set of tool connections or couplings, the hydraulic circuit includes a separate segment or loop of similar hydraulic structure. Each of the pumps 38, 40 have a hydraulic pressure line 44, 46 that leads from the pump 38, 40 to a corresponding pressure hose coupling. Hydraulic return lines 48, 50 lead from each of the return hose couplings to the reservoir 42. In the form shown, the reservoir 42 is a shared reservoir which receives the returned hydraulic fluid from all of the segments of the circuit.

A hydraulic bypass line 60, 62 having relief valves 64, 66 selectively links the hydraulic pressure line 44, 46 to the hydraulic return line 48, 50 depending on the state of an unloading valve 52, 54. The unloading valve 52, 54 is located on a hydraulic bypass line 60, 62 upstream of the relief valves 64, 66. The unloading valves 52, 54 are moveable between (1) a closed state in which the unloading valve 52, 54 is energized and in which all hydraulic fluid running through the corresponding hydraulic pressure line 44, 46 is directed to the pressure hose coupling (for transport to an attached tool 12, 14) and (2) an open state in which the unloading valve 52, 54 is de-energized and in which hydraulic fluid may flow from the hydraulic pressure line 44, 46, through a hydraulic bypass line 60, 62 having relief valves 64, 66, to the hydraulic return line 48, 50.

Looking further at the hydraulic pressure lines 44, 46, each of the hydraulic pressure lines 44, 46 have a high pressure transducer 56, 58 before the downstream pressure hose coupling. The high pressure transducers 56, 58 have a 6,000 psi range and measure the pressure in the corresponding hydraulic pressure line 44, 46.

Each of the hydraulic pressure lines 44, 46 are also connected to a system relief line 68, 70 leading back to the reservoir 42 with a system relief valve 72, 74. In the form shown, the system relief valves 72, 74 are set at 10,500 psi. In an extreme over-pressure condition, these system relief valves 72, 74 will open to direct fluid from hydraulic pressure lines 44, 46 into the reservoir 42 thereby decreasing the line pressure.

The hydraulic return lines 48, 50 in the hydraulic power unit 10 each include a low pressure transducer 76, 78 located upstream of a return flow restrictor check valve 80, 82. The low pressure transducers 76, 78 have a range of 0 psi to 200 psi. The return flow restrictor check valves 80, 82 includes an orifice and a check valve in parallel with one another in which the check valve opens at upstream pressures above 210 psi. As will be apparent from the description below of the mode of operation, the combination of the low pressure transducers 76, 78 and the return flow restrictor check valves 80, 82 effectively function as a flow meter.

With respect to the connectivity of the hydraulic bypass lines 60, 62 between the hydraulic pressure lines 44, 46 and the hydraulic return lines 48, 50, the hydraulic bypass lines 60, 62 connect to the hydraulic return lines 48, 50 at a location downstream of the low pressure transducers 76, 78 and the return flow restrictor check valves 80, 82. Thus, when open, the unloading valves 52, 54 in the hydraulic pressure lines 44, 46 place the hydraulic pressure lines 44, 46 in communication with the corresponding hydraulic return lines 48, 50 at a point downstream of the corresponding flow meter (comprising the low pressure transducer 76, 78 and the return flow restrictor control check valve 80, 82).

A temperature sensor 84 monitors the temperature of the hydraulic fluid in the reservoir 42. As the viscosity of the hydraulic fluid or oil in the circuit may be temperature sensitive, the inclusion of the temperature sensor 84 allows the hydraulic power unit 10 to compensate particular operational parameters such that the parameters are appropriate for fluid operating at the sensed temperature.

A speed sensor 83 may be used to monitor the speed in engine powered units. As the motor speed changes, the inclusion of the speed sensor 83 allows the hydraulic power unit 10 to adjust operational parameters at various speeds.

Although the connectivity is not explicitly shown, a controller 85 is connected to the pressure transducers 56, 58, 76, 78, the unloading valves 52, 54, the temperature sensor 84, and, if present, the speed sensor 83. As will be described in more detail below with respect to the operation of the hydraulic system, the controller 85 will take the readings of the pressure transducers 56, 58, 76, 78 and the temperature sensor 84 and will control the state of the unloading valves 52, 54. Accordingly, the controller 85 is provided with logic and circuitry to allow the hydraulic power unit 10 to operate in the manner now described.

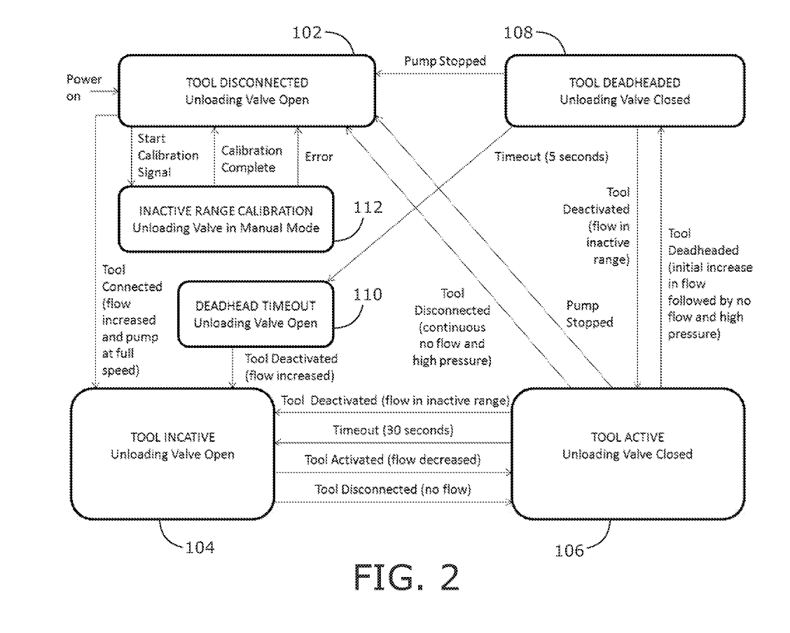

With additional reference to FIG. 2 and in view of the hydraulic system of FIG. 1, the operation of the hydraulic power unit 10 is described. In describing the hydraulic power unit 10, it should be appreciated that specific values may be provided which describe aspects of the particular system illustrated (i.e., particular pressures, dimensions, durations of time, and so forth). These particular values and ranges are for the purposes of illustration and may be modified to provide a system which operates in a similar way but having different operational requirements based on the application.

Initially, the hydraulic power unit 10 is powered on and placed in a disconnected state 102 in which no tools are attached. When no tool is connected, the pump circulates the hydraulic fluid through the connected hydraulic circuit via the bypass line 60, 62 through the open unloading valve 52, 54. The hydraulic configuration is such that, under the flow conditions described above when no tool is connected, the low pressure transducers 76, 78 are substantially isolated from the flow of hydraulic fluid (by the return flow restrictor check valves 80, 82) and provide a no-flow pressure reading to the controller 85.

When one of the tools 12, 14 is hooked up to one of the pair of couplings 24, 26, the hydraulic power unit 10 is able to detect that a tool has been attached and is placed in a tool inactive state 104 in which the tool is known to have been connected, but is currently inactive. When the tool 12, 14 is attached, but inactive, some flow through the forward-inactive-reverse valve 32, 34 will occur which results in the reading of 1.5 psi to 30 psi at the low pressure transducer 76, 78. This return pressure reading at the low pressure transducers 76, 78 indicates that there is flow through the portion of the hydraulic circuit including the tool 12, 14 (i.e., through the now-connected hoses and tool).

To ensure a false positive is not detected, in order to establish the connection of one of the tools 12, 14, a low pressure reading greater than a no-flow level may need to be established at the flow meter in the return line 48, 50 over some duration of time such as, for example, 250 milliseconds and, if a speed sensor 83 is present, a minimum motor speed may also need to be established.

For reference, when a tool 12, 14 is connected a feed pressure in the hydraulic pressure line 44, 46 may be detected by the high pressure transducers 56, 58 to be between 100 psi and 275 psi. In this attached, but inactive state 104, the unloading valve 52, 54 is instructed by the control to be or to remain open such that the hydraulic pressure line 44, 46 is in fluid communication with the hydraulic return line 48, 50 via the hydraulic bypass line 60, 62.

When the tool 12, 14 is connected to the hydraulic power unit 10 and is in a tool inactive state 104, one of two things might happen. Either (1) the tool 12, 14 could be disconnected from the hydraulic power unit 10 or (2) the tool 12, 14 may be activated by operation of the forward-inactive-reverse control valve 32, 34. When either event occurs, the pressure detected at the low pressure transducer 76, 78 will drop indicative of a reduction in the flow through the flow meter in the hydraulic return line 48, 50.

When this pressure drop is detected at one of the low pressure transducers 76, 78, the controller 85 instructs the corresponding unloading valve 52, 54 to close (i.e., energize) and the pump 38, 40 to pump at the first stage rate in the tool active state 106 in FIG. 2. The closing of the unloading valve 52, 54 routes the pumped hydraulic fluid through only the hydraulic pressure line 44, 46 and not the hydraulic bypass line 60, 62 thereby causing pressure to build in the hydraulic pressure line 60, 62. Once the unloading valve 52, 54 is closed, over approximately the next 250 milliseconds, a line pressure builds which will be detected to be in the range of between 400 Psi and 2100 psi at the high pressure transducer 56, 58. Then, depending on the pressure detected at the low pressure transducer 76, 78, the controller 85 will be able to establish whether the tool 12, 14 has been disconnected or activated.

If the tool. 12, 14 has been disconnected, then no pressure/flow will be detected downstream of the tool 12, 14 by the low pressure transducer 76, 78 as no fluid is flowing through the hoses 16, 18, 20, 22 and tool 12, 14. If no pressure/flow is detected by the low pressure transducer 76, 78, this is indicative that the corresponding tool 12, 14 has been disconnected and the controller 85 will instruct the unloading valve 52, 54 to open (i.e., de-energize) to reestablish the hydraulic bypass line 60, 62 connection via the bypass line 60, 62 at low pressure. In this event, the hydraulic power unit 10 returns to the tool disconnected state 102. At this point, the hydraulic power unit 10 may begin to monitor again for tool connection.

On the other hand, if the tool 12, 14 has been activated, the tool 12, 14 will, begin to be actuated and a pressure will be detected at the low pressure transducer 76, 78, indicating flow in the hydraulic return line 48, 50 downstream of the tool 12, 14. Typically, when the tool 12, 14 is active, the return pressures detected by the low pressure transducer 76, 78 will be outside of the inactive range which is 100 psi+/−20 psi for the first stage of pump operation and 50+/−10 psi for the second stage of pump operation. If tool activation is detected, then the unloading valve 52, 54 remains closed under this condition, directing hydraulic fluid into the tool 12, 14.

As the tool 12, 14 experiences an increase in load, the pressure in the hydraulic pressure line 44, 46 will rise to meet load conditions. Given that the pumps 38, 40 are two stage pumps, the hydraulic power unit 10 is configured to monitor the pressures to establish when the pumps 38, 40 should be shifted to the next stage of operation. Likewise, a detected drop in pressure may result in a shift from the second stage of operation back down into the first stage of operation.

if the system relief pressure is approached, which in the particular system illustrated is more than 6,000 psi, after the tool has been activated the flow/pressure detected at the low pressure transducer 76, 78 will, drop and approach zero, thereby indicating that hydraulic fluid is no longer returning from the tool 12, 14. As the high pressure transducers 56, 58 have a maximum range of 6,000 psi, once the detected pressure at the high pressure transducers 56, 58 is detected at 6,000 psi, it is suggestive that a deadhead condition 108 is being approached. When flow stops to the hydraulic return line 48, 50, the low pressure transducer 76, 78 will detect no pressure, indicating no return flow from the tools 12, 14. When the maximum pressure is detected at the high pressure transducer 56, 58 and no pressure is detected at the low pressure transducer 76, 78, the controller 85 maintains the corresponding unloading valve 52, 54 in the closed position for a period of five seconds before entering a deadhead timeout state 110 in which the unloading valve 52, 54 is open to route fluid through one of the hydraulic bypass lines 60, 62 thereby allowing the pressure in the hydraulic pressure line 44, 46 to drop.

The controller will remain in the deadhead timeout state 110 until an increase in flow/pressure at the low pressure transducer 76, 78 is detected, indicating that the cool valve 32, 34 has been returned to the center, inactive, position. Then, the controller will return to the tool inactive state 104, and it will be ready again to detect the reactivation or disconnection of the tool.

When the operation of the tool 12, 14 is stopped by, for example, the re-centering of the forward-inactive-reverse control valve 32, 34 while the unloading valve 52, 54 is closed, then the return pressure detected at the low pressure transducer 76, 78 will return to the inactive range (typically 80 psi to 120 psi). If the tool 12, 14 remains inactive for a duration of time such as, for example, 3 seconds, then the corresponding unloading valve 52, 54 opens (i.e., de-energizes). A re-activation of the tool 12, 14 within this time frame (e.g., within 3 seconds of deactivation) indicated by the detection of active ranges of pressure in the low pressure transducer 76, 78, will reset the timer and, at least temporarily, prevent the corresponding unloading valve 52, 54 from opening at the return to the tool inactive state 104. Once the tool 12, 14, re-enters the inactive state 104, then the controller 85 will again monitor for flow through the return line 48, 50 by monitoring the pressure at the low pressure transducer 76, 78 to indicate either a disconnection or activation of the tool 12, 14.

If the controller 85 remains in the tool active state 106 continuously for more than the specified timeout time, for example 30 seconds, then the hydraulic power unit 10 will return to the tool inactive state 104.

Thus, the disclosed hydraulic power unit is able to detect whether a tool is attached/detached to the hydraulic power unit and, further, if a tool is attached, whether the tool has been activated. This hydraulic configuration allows those attaching and detaching tools, such as rescue or emergency workers, to be able to quickly switch tools on the hydraulic power unit and/or start or stop a tool without the need to manually start or stop one of the pumps and wait while the pressure in the hydraulic circuit is adjusted.

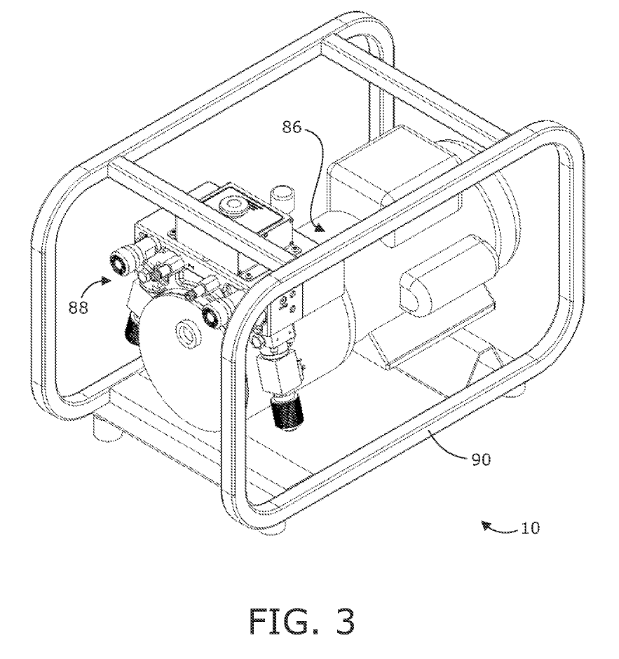

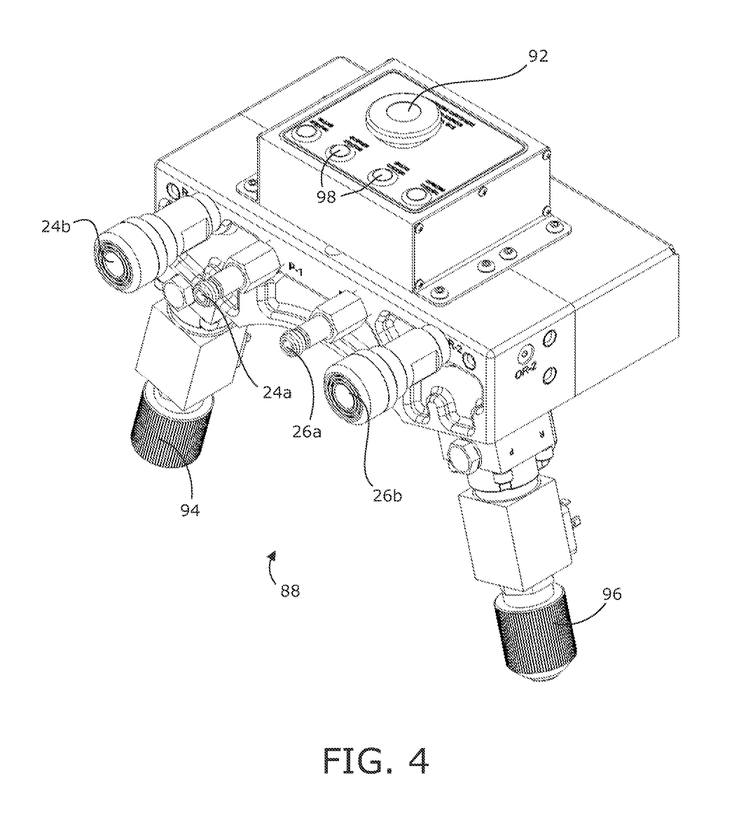

With additional reference to FIGS. 3 and 4, a hydraulic system is shown in which the hydraulic power unit 10 separately includes a pressure source 86 and a manifold 88. A chassis 90 may support the manifold 88 and pressure source 86.

As mapped on the hydraulic schematic of FIG. 1, the pressure source 86 includes the pumps 38, 40, the reservoir 42, and the system relief lines 68, 70 having system relief valves 72, 74. The manifold 88, which is connected to the pressure source 86, houses the remaining portions of the hydraulic circuits and includes one half of the couplings for attachment to the hoses 16, 18, 20, 22 of the tools 12, 14. As best seen in FIG. 4, the manifold 86 includes the set of quick release couplings 24 (including pressure coupling 24a and return coupling 24b) for the first hydraulic tool 12 and the set of quick release couplings 26 (including pressure coupling 26a and return coupling 26b) for the second hydraulic tool 14.

In the form shown, the system also includes a manual override feature for the unloading valves 52, 54. While the system is preferably operated in a smart mode in which the system automatically senses flow to determine the connected state and/or the operational state of the tool(s), there may be conditions under which the system may need to be set to manual operation. For example, having an override provides an important safety feature in the event that the auto-detection features are not properly working or needs to be disabled given the particular working conditions.

To activate the manual override, a user first depresses an emergency stop button 92 on the top of the manifold 88. At this point, the auto-detection features are disabled and the system can be run as though it were a manually operated system. To direct the flow of one of the hydraulic circuits to the attached tool, the user operates a valve manual override 94, 96 for the corresponding circuit. In the form shown, the valve manual override 94 will control the flow to the first tool 12 through the couplings 24a and 24b (which share the same side of the manifold 88) and the valve manual override 96 will control the flow to the second tool 14 through the couplings 26a and 26b. To close the valve manual override 94, 96 and the corresponding unloading valve 52, 54, the end of the override 94, 96 is lifted against a biasing force toward the manifold 88 and twisted to temporarily lock the override 94, 96 in place (in a motion similar to the manner in which a bayonet-style connection is formed). To re-open unloading valve 52, 54 using the valve manual override 94, 96, the valve manual override 94, 96 is twisted in the opposite direction and the biasing force causes the corresponding unloading valve 52, 54 to open.

The hydraulic power unit 10 may also have a calibration sequence to establish operational parameters. Now with reference back to FIG. 2, the calibration sequence will be described. To calibrate each pump 38, 40, the hydraulic power unit 10 and the controller 85 are powered on and allowed to run for at least three minutes. During this warm up period, the tools 12, 14 are connected and operated a few times. Then, the tools 12, 14 are disconnected so that the hydraulic power unit 10 is placed in the tool disconnected state 102. At this point, the temperature sensor 84 is unplugged and the user waits for the red LEDs 98 to flash four times. The temperature sensor 84 is then reconnected within 10 second of the final flash of the LEDs 98 to initiate the calibration mode 112. If the calibration mode 112 is entered then the red LEDs 98 will stay solid and lit, otherwise the temperature sensor 84 may need to be unplugged again and reconnected to again try to initiate the calibration mode 112.

Once the calibration mode 112 has been entered (as indicated by the red LEDs 98 remaining lit), then the hoses for the pump 38, 40 to be calibrated are connected to the appropriate couplings (typically only one pump will be tested at a time). To ensure accurate calibration, the tool 12, 14 should be connected using hoses of 100 feet in length, preferably, or, if hoses of that length are not available, then using hoses of the longest length available. After the tool 12, 14 has been connected the LED 98 corresponding to the pump that is not connected to by a tool will turn off. At this point, the user should turn on the valve manual override 96, 98 on the pump to be calibrated. The LEDs 98 for that pump 38, 40 will remain lit during calibration and turn off once the pump 38, 40 has been calibrated. Once the LEDs 98 are off, the user should turn off the valve manual override 96, 98. Now the user should depress the emergency stop button 92 to turn off the controller 85, wait five seconds, and reset the emergency stop button 92.

At this point, the tool can be tested to ensure the calibration of the pump has been properly completed using five tests. First, the tool should be extended and stopped in mid-stroke. The pump should time out after 3 to 5 seconds and the hydraulic power unit will unload. Second, the tool should be retracted and stopped in mid-stroke. Again, the pump should time out after 3 to 5 seconds and the hydraulic power unit should unload. Third, the tool should be extended until the tool bottoms and the pump dead heads. In this condition, the hydraulic power unit should unload after 5 to 10 seconds. Fourth, the pressure side should be disconnected. The corresponding pump should momentarily load and unload. Finally, the pressure hose should be reconnected with the unit running. If any of these tests malfunction, then the calibration mode 112 should be reentered to recalibrate the unit.

Thus, by placing the portions of the hydraulic power unit which are responsible for load detection in the manifold 88, a manifold 88 may be provided for connection to a pressure source 86 which otherwise would not have auto-load sensing capabilities of the manner described above. This is particularly advantageous because a manifold 88 containing the load detection components may be retro-fit onto a pressure source which alone would not, be capable of automatic load detection to establish a connected/disconnected tool state and an active/inactive tool state when a tool is connected.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A hydraulic power unit for selective connection to a hydraulic tool, the hydraulic power unit comprising:
a pressure source;
a hydraulic circuit coupled to the pressure source, the hydraulic circuit including a pressure line extending to a pressure connector and a return line extending from a return connector for selective connection to the hydraulic tool, the hydraulic circuit further including an unloading valve for selectively placing a pressure line and a return line in fluid communication with one another via a bypass line; and
a flow meter in fluid communication with the hydraulic circuit.

2. The hydraulic power unit of claim 1, wherein the flow meter is located along the return line between the return connector and a connection between the bypass line and the return line.

3. The hydraulic power unit of claim 2, wherein the return line includes a pressure transducer and a downstream orifice that comprise the flow meter.

4. The hydraulic power unit of claim 2, wherein the return line includes a pressure transducer and a downstream return flow restrictor check valve that comprise the flow meter.

5. The hydraulic power unit of claim 2, wherein, when the hydraulic power unit is powered on and no tool is connected, the unloading valve is open to place the pressure line and the return line in fluid communication via the bypass line.

6. The hydraulic power unit of claim 4, wherein the flow meter is configured to monitor a flow in the return line of the hydraulic circuit to establish a connectivity state of the hydraulic tool.

7. The hydraulic power unit of claim 6, wherein the hydraulic power unit is configured such that, when a hydraulic tool is connected and a flow decrease is detected by the flow meter in the return line, then the unloading valve is closed so that the pressure line and the return line are not in fluid communication via the bypass line.

8. The hydraulic power unit of claim 7, further comprising a pressure transducer in the pressure line configured to detect a deadhead condition of the hydraulic tool.

9. The hydraulic power unit of claim 8, wherein the hydraulic power unit is further configured such that, after the unloading valve is closed, if the flow decrease is a sustained no-flow condition and the pressure transducer on the pressure line detects a pressure exceeding a pressure associated with the deadhead condition, then the unloading valve is opened as the hydraulic tool has been disconnected.

10. The hydraulic power unit of claim 8, wherein the hydraulic power unit is further configured such that, after the unloading valve is closed, if the flow increases initially, followed by a no-flow condition and the pressure transducer on the pressure line detects a pressure exceeding a pressure associated with the deadhead condition, then the unloading valve is opened as the hydraulic tool is in a deadhead condition.

11. The hydraulic power unit of claim 1, wherein the hydraulic power unit is adapted to receive more than one hydraulic tool.

12. The hydraulic power unit of claim 1, further comprising a controller in electrical communication with the flow meter and the unloading valve;
wherein said controller is configured to detect at least one of a connected/disconnected state of the hydraulic tool and an active/inactive state of the hydraulic tool and is further configured to actuate the unloading valve between an open state and a close state.

13. The hydraulic power unit of claim 12, further comprising an emergency stop configured to disable the controller and permit the hydraulic power unit to be manually operated.

14. A hydraulic power unit for selective connection to a hydraulic tool, the hydraulic power unit comprising:
a pressure source for pumping hydraulic fluid from a reservoir;
at least one hydraulic circuit including:
a pressure line extending from the pressure source to a pressure coupling for the hydraulic tool, the pressure line having a first pressure transducer attached thereto;
a return line extending from a return coupling for the hydraulic tool to the reservoir, the return line having a flow meter;
a bypass line for selectively placing the hydraulic pressure line in fluid communication with the return line at a location downstream of the flow meter, the bypass line having an unloading valve thereon which is moveable between an open state in which the bypass line places the pressure line in communication with the return line and a closed state in which all fluid is pumped toward the pressure coupling.

15. The hydraulic power unit of claim 14, further comprising a controller in electrical communication with the first and second pressure transducers and the unloading valve;
wherein said controller is configured to detect at least one of a connected/disconnected state of the hydraulic tool and an active/inactive state of the hydraulic tool and actuate the unloading valve between an open state and a close state.

16. The hydraulic power unit of claim 14, wherein the flow meter is a second pressure transducer and a return flow restrictor check valve downstream of the second pressure transducer.

17. The hydraulic power unit of claim 14, wherein the flow meter is a second pressure transducer and an orifice downstream of the orifice.

18. A sensor and control manifold for attachment to a hydraulic power unit, the manifold comprising:
a pressure line extending from a coupling a pressure source to a pressure coupling for the hydraulic tool, the pressure line having a first pressure transducer attached thereto;
a return line extending from a return coupling for the hydraulic tool to coupling to a reservoir of the pressure source, the return line having a second pressure transducer attached thereto and a return flow restrictor check valve downstream of the second pressure transducer;
a bypass line for selectively placing the hydraulic pressure line in fluid communication with the return line at a location downstream of the return flow restrictor check valve, the bypass line having an unloading valve thereon which is actuateable between an open state in which the bypass line places the pressure line in fluid communication with the return line and a closed state in which the pressure line is not in fluid communication with the return line.
